(19) United States
(12) Patent Application Publication
(10) Pub. No.: US 2021/0199862 A1
(43) Pub. Date: Jul. 1, 2021

(54) COLOR FILM SUBSTRATE, FABRICATION METHOD THEREOF, AND DISPLAY DEVICE

(71) Applicants: BOE TECHNOLOGY GROUP CO., LTD., Beijing (CN); Fuzhou BOE Optoelectronics Technology Co., Ltd., Fuzhou, Fujian (CN)

(72) Inventors: Shijian Luo, Beijing (CN); Hui Chen, Beijing (CN); Xinyu Zhang, Beijing (CN)

(73) Assignees: BOE TECHNOLOGY GROUP CO., LTD., Beijing (CN); Fuzhou BOE Optoelectronics Technology Co., Ltd., Fuzhou, Fujian (CN)

(21) Appl. No.: 16/066,188

(22) PCT Filed: Dec. 15, 2017
(86) PCT No.: PCT/CN2017/116514

§ 371 Date: Jun. 26, 2018

(30) Foreign Application Priority Data
Mar. 20, 2017 (CN) 201710166415.X

(51) Int. Cl. G02B 5/20; G02F 1/1335; G02F 1/13357

(52) U.S. Cl. CPC G02B 5/206; G02F 1/133516; G02F 2202/36; G02F 1/133512; G02F 1/133528; G02F 1/133617

(57) ABSTRACT

A color film substrate includes a substrate, a light-shielding matrix, and a functional composite layer. The light-shielding matrix is over the substrate. The functional composite layer is over the substrate and is electrically conductive. The functional composite layer includes a composite material including a quantum dot and a graphene and is configured to convert white light into color light.

### CROSS-REFERENCE TO RELATED APPLICATION

This PCT patent application claims priority to Chinese Patent Application No. 201710166415.X, filed on Mar. 20, 2017, the entire contents of which are incorporated herein by reference.

### TECHNICAL FIELD

The present disclosure generally relates to the field of display technologies and, more particularly, to a color film substrate, a fabrication method thereof, and a display device.

### BACKGROUND

A color film substrate in a conventional thin film transistor liquid crystal display (TFT-LCD) includes a substrate, and a light-shielding matrix, a color filter layer, a common electrode, and a photo spacer (PS) layer successively formed over the substrate. A color filter layer in the conventional TFT-LCD includes a red (R) filter unit, a green (G) filter unit, and a blue (B) filter unit. The light-shielding matrix has a plurality of open regions, each of which includes a filter unit. A common electrode can be formed over the color filter layer by a sputter process, using indium tin oxide (ITO) as a material.

### SUMMARY

In one aspect, the present disclosure provides a color film substrate including a substrate, a light-shielding matrix, and a functional composite layer. The functional composite layer is over the substrate and is electrically conductive. The functional composite layer includes a composite material including a quantum dot and a graphene and is configured to convert white light into color light.

In some embodiments, a weight percentage of the quantum dot in the composite material is in a range from approximately 10% to approximately 20%. A weight percentage of the graphene in the composite material is in a range from approximately 40% to approximately 65%.

In some embodiments, the functional composite layer includes a plurality of color conductive units that have approximately equal thicknesses.

In some embodiments, the plurality of color conductive units include a red conductive unit, a green conductive unit, and a blue conductive unit.

In some embodiments, the red conductive unit includes a red composite material, the green conductive unit includes a green composite material, and the blue conductive unit includes a blue composite material.

In some embodiments, the thicknesses of the color conductive units are in a range from approximately 1.5 mm to approximately 2.5 mm.

In some embodiments, a light-shielding matrix is arranged over the substrate, the light-shielding matrix includes a plurality of open regions that are arranged in an array. One of the color conductive units is arranged in one of the open regions.

In some embodiments, the color film substrate further includes a polarizer layer arranged over the functional composite layer.

In some embodiments, the color film substrate further includes a photo spacer layer arranged over the polarizer layer.

In some embodiments, the functional composite layer has a multilayer structure.

Another aspect of the present disclosure provides a method for fabricating a color film substrate. The method includes providing a substrate; and forming a functional composite layer over the substrate using at least one composite material including a quantum dot and a graphene. The functional composite layer is electrically conductive.

In some embodiments, forming the functional composite layer over the substrate includes forming a composite layer by a coating process.

In some embodiments, the method further includes forming a light-shielding matrix over the substrate. The light-shielding matrix includes a plurality of open regions. Forming the functional composite layer over the substrate includes forming a plurality of color conductive units. One of the color conductive units is framed in one of the open regions of the light-shielding matrix.

In some embodiments, forming the functional composite layer over the substrate includes forming a red conductive unit in a first one of the open regions of the light-shielding matrix by a first coating process using a red composite material including a red quantum dot; forming a green conductive unit in a second one of the open regions of the light-shielding matrix by a second coating process using a green composite material including a green quantum dot; and forming a blue conductive unit in a third one of the open regions of the light-shielding matrix by a third coating process using a blue composite material including a blue quantum dot.

In some embodiments, the method further includes forming a polarizer layer over the functional composite layer.

In some embodiments, the method further includes forming a photo spacer layer over the polarizer layer.

Another aspect of the present disclosure provides a display device including a color film substrate.

### BRIEF DESCRIPTION OF THE FIGURES

The following drawings are merely examples for illustrative purposes according to various disclosed embodiments and are not intended to limit the scope of the present disclosure.

FIG. 1 illustrates a schematic view of a display device in the conventional technologies.

FIG. 2 illustrates a schematic view of an exemplary color film substrate according to various disclosed embodiments of the present disclosure;

FIG. 3 illustrates another schematic view of an exemplary color film substrate according to various disclosed embodiments of the present disclosure;

FIG. 4 illustrates a flow chart of an exemplary fabrication method for an exemplary color film substrate according to various disclosed embodiments of the present disclosure;

FIG. 5 illustrates a schematic view of an exemplary structure after a light-shielding matrix is formed over a substrate according to various disclosed embodiments of the present disclosure;

FIG. 6 illustrates a flow chart of an exemplary method of forming an exemplary functional composite layer according to various disclosed embodiments of the present disclosure;

FIG. 7 illustrates a schematic view of an exemplary structure after a red conductive unit is formed over a substrate over which a light-shielding matrix has been formed according to various disclosed embodiments of the present disclosure;

FIG. 8 illustrates a schematic view of forming a red conductive unit over a substrate over which a light-shielding matrix has been formed according to various disclosed embodiments of the present disclosure;

FIG. 9 illustrates a schematic view of an exemplary structure after a green conductive unit is formed over a substrate over which a red conductive unit has been formed according to various disclosed embodiments of the present disclosure;

FIG. 10 illustrates a schematic view of forming a green conductive unit over a substrate over which a red conductive unit has been formed according to various disclosed embodiments of the present disclosure;

FIG. 11 illustrates a schematic view of an exemplary structure after a blue conductive unit is formed over a substrate over which a green conductive unit has been formed according to various disclosed embodiments of the present disclosure;

FIG. 12 illustrates a schematic view of forming a blue conductive unit over a substrate over which a green conductive unit has been formed according to various disclosed embodiments of the present disclosure;

FIG. 13 illustrates a schematic view of an exemplary structure after a polarizer layer is formed over a substrate over which a functional composite layer has been formed according to various disclosed embodiments of the present disclosure;

FIG. 14 illustrates a schematic view of an exemplary display device according to various disclosed embodiments of the present disclosure; and

FIG. 15 illustrates a schematic view showing an operation of an exemplary display device according to various disclosed embodiments of the present disclosure.

### DETAILED DESCRIPTION

Exemplary embodiments of the disclosure will now be described in more detail with reference to the drawings. It is to be noted that, the following descriptions of some embodiments are presented herein for purposes of illustration and description only, and are not intended to be exhaustive or to limit the scope of the present disclosure.

The aspects and features of the present disclosure can be understood by those skilled in the art through the exemplary embodiments of the present disclosure further described in detail with reference to the accompanying drawings.

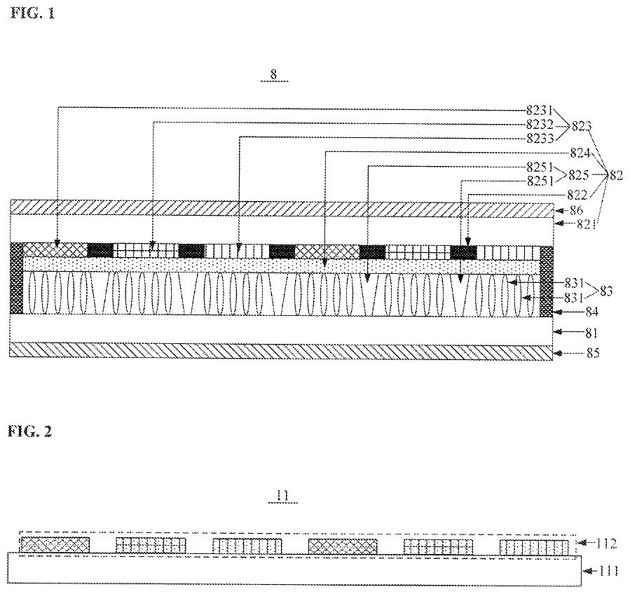

FIG. 1 illustrates a schematic view of a display device 8 in the conventional technologies. As shown in FIG. 1, the display device 8 includes an array substrate 81 and a color film substrate 82 paired to form a box, and a liquid crystal layer 83 between the array substrate 81 and the color film substrate 82. The liquid crystal layer 83 includes a plurality of liquid crystal molecules 831. A sealing frame 84 is provided between the array substrate 81 and the color film substrate 82. The liquid crystal molecules 831 are located in a space enclosed by the sealing frame 84.

As shown in FIG. 1, the array substrate 81 has one side feeing away from the liquid crystal layer 83, and the side feeing away from the liquid crystal layer 83 is attached with an upper polarizer plate 85. The color film substrate 82 has one side facing away from the liquid crystal layer 83, and the side feeing away from the liquid crystal layer 83 is attached with a lower polarizer plate 86. Generally, a polarization direction of the upper polarizer plate 85 may be perpendicular to a polarization direction of the lower polarizer plate 86, such that light can pass through the display device 8. The display device 8 may use the upper polarizer plate 85 and the lower polarizer plate 86, in conjunction with liquid crystal molecules 831 in the liquid crystal layer 83, to achieve image display.

As shown in FIG. 1, the color film substrate 82 includes a substrate 821, and a light-shielding matrix 822, a color filter layer 823, a common electrode 824, and a photo spacer layer 825 successively arranged over the substrate 821. The color filter layer 823 includes a red filter unit 8231, a green filter unit 8232, and a blue filter unit 8233. The light-shielding matrix 822 includes a plurality of open regions, each of which is provided with a fiber unit. The photo spacer layer 825 includes a plurality of photo spacers 8251. The photo spacers 8251 can support the array substrate 81 and the color film substrate 82, such that a space is formed between the array substrate 81 and fee color film substrate 82. The liquid crystal molecules 831 are located in the space formed wife a support of fee photo spacers 8251.

The array substrate 81 may include a substrate (not shown in FIG. 1), and a gate electrode (not shown in FIG. 1), a gate insulating layer (not shown in FIG. 1), an active layer (not shown in FIG. 1), a source-drain electrode metal layer (not shown in FIG. 1), a passivation layer (not shown in FIG. 1), pixel electrodes (not shown in FIG. 1), and other appropriate structures successively arranged over the substrate.

In the color film substrate 82, the color filter layer 823 may generally be formed of a polymer color resist material. Ingredients of the polymer color resist material may generally include one or more of a resin, a multifunctional monomer, an initiator, a raw material, a dispersant, a solvent, an additive, etc. After the color filter layer 823 is formed, the common electrode 824 may be formed over the color filter layer 823 by a sputter process using indium tin oxide (ITO) as a material. A height of each filter unit of the color filter layer 823 may be non-uniform, resulting in a Red-Green-Blue (RGB) segment difference. The RGB segment difference may result in poor uniformity of a subsequently formed polyimide film, and may finis result in mura. An over cover (OC) layer (not shown in FIG. 1) may generally be formed over the color filter layer 823 to achieve a smooth surface, and then the common electrode 824 may be formed over the OC layer by a sputter process.

However, in the conventional technologies, if the color film substrate 82 does not include an OC layer, because the color film substrate 82 includes both the color filter layer 823 and the common electrode 824, the color film substrate 82 may be relatively thick, causing difficulties in realizing a thin and light-weight display device. In addition, since a sputter process is used to form the common electrode 824 over the color filter layer 823, the sputter process may cause a certain damage to the color filter layer 823. On the other hand, if the color film substrate 82 includes an OC layer, because the color film substrate 82 includes the color filter layer 823, the OC layer, and the common electrode 824, the thickness of the color film substrate 02 may be increased. Further, because of a material of the color filter layer 823, the color film substrate 82 may have a relatively narrow color gamut range, a relatively low color saturation, and a relatively poor display performance.

FIG. 2 illustrates a schematic view of an exemplary color film substrate 11 according to various disclosed embodiments of the present disclosure. As shown in FIG. 2, the exemplary color film substrate 11 includes a substrate 111 and a functional composite layer 112 disposed over the substrate 111. The functional composite layer 112 can be electrically conductive and can convert white light into color light. The color film substrate can also be referred to as a color filter substrate.

The functional composite layer 112 may be formed of at least one composite material. The composite material may include a quantum dot and a graphene.

The present disclosure provides a color film substrate. The color film substrate of the disclosure may include a functional composite layer which is electrically conductive and capable of converting white light into color light. Thus, the functional composite layer may serve as a color filter layer and a common electrode. That is, the function of the color filter layer and the function of the common electrode can be realized simultaneously by the functional composite layer. Accordingly, the color film substrate of the disclosure may have a relatively small number of layers, as compared to the conventional technologies in which a color film substrate may have a relatively large thickness and a thin and light-weight device may be difficult to achieve. The color film substrate of the disclosure may have a relatively small thickness, facilitating the realization of a thin and light-weight display device.

The substrate 111 may be a transparent substrate, and may be, for example, a substrate formed of a transparent non-metal material having a certain strength, such as a glass, a quartz, a transparent resin, or the like.

In the present disclosure, the functional composite layer 112 may be formed of at least one composite material. Ingredients of the composite material may include one or more of a quantum dot, a graphene, an adhesive, a curing agent, an accelerant, a diluent, etc. The quantum dot may have a size between approximately 1 nm and approximately 10 nm. Due to electron and hole quantum confinement, a quantum confinement effect may exist. Accordingly, a continuous band structure may turn into a structure with discrete energy levels like molecules. Thus, an excited emission peak of the quantum dot may be narrow, and a spectrum intensity of the quantum dot may be high. In embodiments of the present disclosure, the quantum dot may be mainly used for converting white light into color light, and a weight percentage of the quantum dot in the composite material may range from approximately 10% to approximately 20%. If the weight percentage of the quantum dot in the composite material is less than approximately 10%, a relative amount of the quantum dot may be relatively small, and a luminous efficiency of the quantum dot may be affected. If the weight percentage of the quantum dot in the composite material is greater than approximately 20%, a thermodynamic chemical agglomeration reaction among quantum dots may occur due to the small particle sizes of the quantum dots, causing the quantum dots to agglomerate. As a result, light transmittance may be reduced, and a luminous efficiency of the quantum dot may be affected.

The graphene may be mainly used for conducting electricity. A weight percentage of the graphene may range from approximately 40% to approximately 65%. In the composite material, if the weight percentage of the graphene is greater than approximately 65%, a relative amount of the quantum dot may be relatively small, and the luminous efficiency of the quantum dot may be affected. If the weight percentage of the graphene in the composite material is less than approximately 40%, a conductivity of the conductive layer may be affected, which may affect a voltage between a pixel electrode and the conductive layer, and hence affect a twisting performance of the liquid crystal. The adhesive may cause the composite material to have a certain viscosity and a certain degree of adhesion. The adhesive may include epoxy resin, e.g., bisphenol A-type epoxy resin. A weight percentage of the adhesive may range from approximately 20% to approximately 40%. The curing agent can make the quantum dots cured mi a surface of graphene layers. The curing agent may include dicyandiamide, p-phenylenediamine, or another suitable material. A weight percentage of the curing agent may range from approximately 1% to approximately 10%. The accelerant may serve as an additive, and may include imidazole, dimethylimidazole, triethylamine, or another appropriate material. A weight percentage of the accelerant may range from approximately 0.3% to approximately 8%. The diluent may serve as an additive, and may include at least one of isopropanol, acetone, or n-butanol. A weight percentage of the diluent may range from approximately 3% to approximately 10%. The above descriptions of the composite material are merely for illustrative and exemplary purposes. The composite material may include other ingredients, and the weight percentages of the ingredients may be selected in different ranges according to various application scenarios, which are not limited in the present disclosure.

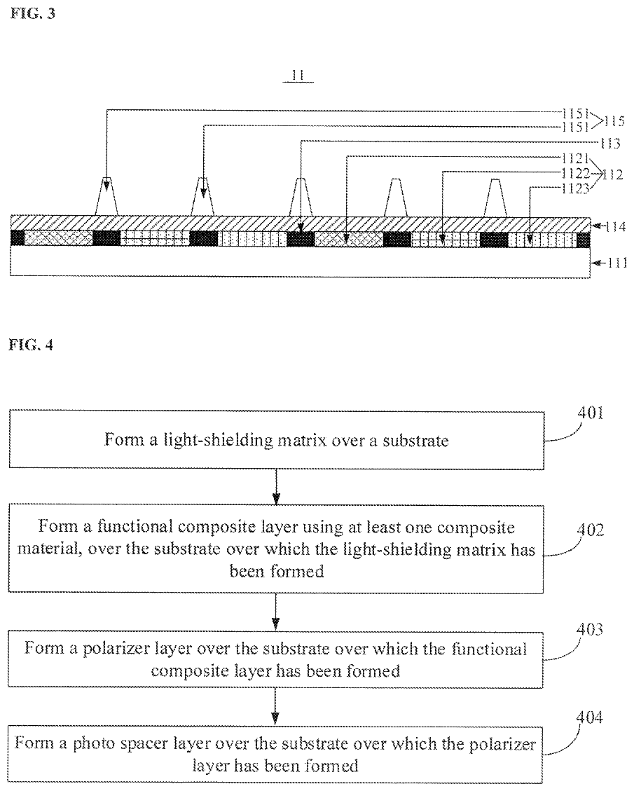

FIG. 3 illustrates another schematic view of the exemplary color film substrate 11 according to various disclosed embodiments of the present disclosure. As shown in FIG. 3, the functional composite layer 112 includes a plurality of color conductive units. As used in this disclosure, unless otherwise specified, the term “conductive” refers to “electrically conductive.” The plurality of color conductive units include a red conductive unit 1121, a green conductive unit 1122, and a blue conductive unit 1123, all of which may have equal thicknesses. In some embodiments, the thicknesses of the color conductive units may range from approximately 1.5 mm to approximately 2.5 mm. The equal thicknesses of the color conductive units may prevent mura caused by segment differences between different color conductive units from occurring. In some embodiments, the functional composite layer 112 may be formed by a coating process, an ink-jet printing process, a transfer process, a drop casting process, or another appropriate process. Accordingly, a conductive unit of each color may be formed by a coating process, an ink-jet printing process, a transfer process, a drop casting process, or another appropriate process. In some embodiments, a forming material of the red conductive unit 1121 may include a red composite material, a forming material of the green conductive unit 1122 may include a green composite material, and a forming material of the blue conductive unit 1123 may include a blue composite material. A quantum dot in the red composite material may include a red quantum dot, which may mainly include, for example, a II-VI quantum dot, the red quantum dot is used for emitting red light under the excitation of blue light. A quantum dot in the green composite material may include a green quantum dot, which may mainly include, for example, a I-III-VI quantum dot. A quantum dot in the blue composite material may include a blue quantum dot, which may mainly include, for example, a rare-earth quantum dot, the green quantum dot is used for emitting green light under the excitation of blue light. Reference can be made to the above descriptions about the composite material, for ingredients of the red composite material, the green composite material, and the blue composite material, and for functions and weight percentages of the ingredients, which are not repeated here.

In some embodiments, the functional composite layer 112 may have a multilayer structure (not shown in FIG. 3). Accordingly, each color conductive unit may have a multilayer structure. That is, each color conductive unit may include a plurality of sublayers. In some embodiments, each sublayer may be formed by a coating process, an ink-jet printing process, a transfer process, a drop casting process, or anther appropriate process. In practical applications, a color conductive unit may fall off, causing a corresponding sub-pixel to fail, and resulting in a poor display performance of the color film substrate. In embodiments of the present disclosure, because the color conductive unit may have a multilayer structure, if one sublayer in the color conductive unit falls off, other sublayers may still function properly. As a result, the display performance of the color film substrate may be better.

Further, as shown in FIG. 3, the color film substrate 11 includes a light-shielding matrix 113 disposed over the substrate 111. The light-shielding matrix 113 includes a plurality of open regions (not marked in FIG. 3), and each open region is provided with one of the color conductive units of the functional composite layer 112. The open regions may be arranged in an array.

Further, as shown in FIG. 3, the color film substrate 11 includes a polarizer layer 114 disposed over the functional composite layer 112. In some embodiments, the polarizing layer 114 may, for example, include a polarizer plate, which may be attached to the functional composite layer 112. In some embodiments, the functional composite layer 112 may be formed of at least one composite material. A surface of the composite material may include one or more of a hydroxyl group (—OH), a carboxyl group (—COOH), and other appropriate functional groups. The hydroxyl group (—OH), the carboxyl group (—COOH), or the other appropriate functional group may cause the composite material to be hydrophilic to a certain degree. A material of the polarizer plate may have a certain water solubility. Thus, the hydroxyl group (—OH), the carboxyl group (—COOH), or the other appropriate functional group may attach the polarizer plate to the functional composite layer 112. The manner of disposing the polarizer plate over the functional composite layer 112 is not restricted in the present disclosure, and may be selected according to various application scenarios.

Further, as shown in FIG. 3, the color film substrate 11 includes a photo spacer layer 115 disposed over the polarizer layer 114. The photo spacer layer 115 includes a plurality of photo spacers 1151. The photo spacers 1151 may each have a columnar structure, e.g., a cylindrical structure, a circular table structure, a prismatic structure, or the like. In some embodiments, as shown in FIG. 3, the photo spacer 1151 has a trapezoidal vertical cross section. The photo spacers 1151 may be similar to the photo spacers 8251 shown in FIG. 1, and thus detailed description thereof is omitted.

The present disclosure provides a color film substrate. The color film substrate of the disclosure may include a functional composite layer which is electrically conductive and capable of converting white light into color light. Thus, the functional composite layer may serve as a color filter layer and a common electrode. That is, the function of the color filter layer and the function of the common electrode can be realized by the functional composite layer. Accordingly, the color film substrate of the disclosure may have a relatively small number of layers, as compared to the conventional technologies in which a color film substrate may have a relatively large thickness and a thin and light-weight device may be difficult to achieve. The color film substrate of the disclosure may have a relatively small thickness, facilitating the realization of a thin and light-weight display device.

Further, in the color film substrate of the disclosure, the function of a color filter layer may be realized by using a quantum dot. The quantum dot may include, for example, at least one of a red quantum dot, a green quantum dot, a blue quantum dot, or another appropriate quantum dot. The quantum dot may have a high spectrum intensity and a wide color gamut range. Thus, the color film substrate may have a relatively wide color gamut range, a relatively high color saturation, a relatively high color contrast, and a relatively good display performance. Further, in the color film substrate of the disclosure, the function of the common electrode may be realized by using a graphene, with no need to further provide a common electrode. Accordingly, a dependence on a sputter target may be suppressed, a production cost may be reduced, and a damage to fire color film substrate, caused by a sputter process for forming fire common electrode, may be reduced.

A fabrication method and fabrication principles for the color film substrate of the present disclosure are described below with reference to the drawings.

The present disclosure provides a fabrication method for a color film substrate. The fabrication method can be used to fabricate, for example, the color film substrate shown in FIG. 2 or FIG. 3. The fabrication method may include the following.

At least one composite material may be used to form a functional composite layer over a substrate. The functional composite layer can be electrically conductive and can convert white light into color light. The composite material may include a quantum dot and a graphene. The quantum dot may include, for example, at least one of a red quantum dot. green quantum dot, a blue quantum dot, or another appropriate quantum dot.

In some embodiments, after forming the functional composite layer over the substrate using the composite material, the method may further include forming a polarizer layer over the substrate over which the functional composite layer has been formed.

In some embodiments, before forming the functional composite layer over the substrate using the at least one composite material, the method may include forming a light-shielding matrix over the substrate, where the light-shielding matrix may include a plurality of open regions.

Forming the functional composite layer over the substrate by using the at least one composite material may include forming the functional composite layer using the at least one composite material, over the substrate over which the light-shielding matrix has been formed, where the functional composite layer may include a plurality of color conductive units, each of which may be located in an open region of the light-shielding matrix.

In some embodiments, after forming the polarizer layer over the substrate over which the functional composite layer has been formed, the method may further include forming a photo spacer layer over the substrate over which the polarizer layer has been formed.

In some embodiments, the plurality of color conductive units may include a red conductive unit, a green conductive unit and a blue conductive unit. The at least one composite material may include a red composite material, a green composite material and a blue composite material. Forming the functional composite layer using the at least one composite material, over the substrate over which the light-shielding matrix has been formed, may include: forming the red conductive unit by a coating process and by using the red composite material, over the substrate over which the light-shielding matrix have been formed; forming the green conductive unit by a coating process and by using the green composite material, over the substrate over which the red conductive unit has been formed; forming the blue conductive unit by a coating process and by using the blue composite material, over the substrate over which the green conductive unit has been formed, and thus to form the functional composite layer.

In some embodiments, the red composite material may include a red quantum dot, the green composite material may include a green quantum dot, and the blue composite material may include a blue quantum dot.

Any of the above-described technical solutions may form embodiments of the present disclosure by any combination, which is not described further here.

The present disclosure provides a fabrication method for a color film substrate. The color film substrate may include a functional composite layer which is electrically conductive and capable of converting white light into color light. Thus, the functional composite layer may serve as a color filter layer and a common electrode. That is, the function of the color filter layer and the function of the common electrode can be realized by the functional composite layer. Accordingly, the color film substrate fabricated by the disclosed fabrication method may have a relatively small number of layers, as compared to the conventional technologies in which a color film substrate may have a relatively large thickness and it may be hard to achieve a thin and light-weight device. The color film substrate fabricated by the disclosed fabrication method may have a relatively small thickness, facilitating the realization of a thin and light-weight display device.

FIG. 4 illustrates a flow chart of an exemplary fabrication method for an exemplary color film substrate according to various disclosed embodiments of the present disclosure. The fabrication method can be used for fabricating, for example, the color film substrate 11 as shown in FIG. 2 or FIG. 3. The fabrication method is described below with reference to FIG. 4.

At 401, a light-shielding matrix is formed over a substrate. The light-shielding matrix includes a plurality of open regions.

FIG. 5 illustrates a schematic view of an exemplary structure after the light-shielding matrix 113 is formed over a substrate 111 according to various disclosed embodiments of the present disclosure. The substrate 111 may be a transparent substrate, and may be, for example, a substrate formed of a transparent non-metal material having a certain strength, such as a glass, a quartz, a transparent resin, or the like. The light-shielding matrix 113 includes a plurality of open regions A. In some embodiments, the light-shielding matrix 113 may be formed of a black resin material. A thickness of the light-shielding matrix 113 may be selected according to various application scenarios, which is not limited in the present disclosure.

In some embodiments, a layer of black resin material may be coated over the substrate 111 to form a black resin layer, and then the black resin layer may be processed by a patterning process to form the light-shielding matrix 113. The patterning process may include photoresist (PR) coating, exposure, development, etching, and photoresist peeling. Thus, processing the black resin layer by the patterning process to form the light-shielding matrix 113 may include: coating a layer of photoresist having a certain thickness over the black resin layer to form a photoresist layer; exposing the photoresist layer by using a mask plate, such that fully exposed regions and non-exposed regions are formed in the photoresist layer, using a development process to remove photoresist in the fully exposed regions of the photoresist layer and to retain photoresist in the non-exposed regions of the photoresist layer, etching regions of the black resin layer corresponding to the fully exposed regions by an etching process; forming the light-shielding matrix 113 after peeling off the photoresist in the non-exposed regions. In some embodiments, the regions of the black resin layer corresponding to the fully exposed regions may be etched by a dry etching method. The manner of etching the regions of the black resin layer corresponding to the fully exposed regions is not restricted in the present disclosure, and may be selected according to various application scenarios.

In embodiments of the present disclosure, descriptions are made for scenarios that a positive photoresist is adopted to form the light-shielding matrix 113, as examples, hi some other embodiments, a negative photoresist may be adopted to form the light-shielding matrix 113. Whether a positive photoresist or a negative photoresist is selected to form the light-shielding matrix 113 is not restricted in the present disclosure.

At 402, a functional composite layer is formed using at least one composite material, over the substrate over which the light-shielding matrix has been formed. The functional composite layer includes a plurality of color conductive units. Each color conductive unit is located in one of the open regions A.

As shown in FIG. 3, the functional composite layer 112 includes a plurality of color conductive units. The plurality of color conductive units include a red conductive unit 1121, a green conductive unit 1122, and a blue conductive unit 1123. Thus, when the functional composite layer 112 is formed, the red conductive unit 1121, the green conductive unit 1122, and the blue conductive unit 1123 may be formed, respectively. The functional composite layer 112 may be formed of at least one composite material including a quantum dot and a graphene. The quantum dot may include, for example, at least one of a red quantum dot, a green quantum dot, a blue quantum dot, or another appropriate quantum dot. The graphene can be electrically conductive, and the quantum dot can convert white light into color light. Thus, the functional composite layer 112 can be electrically conductive and can convert white light into color light.

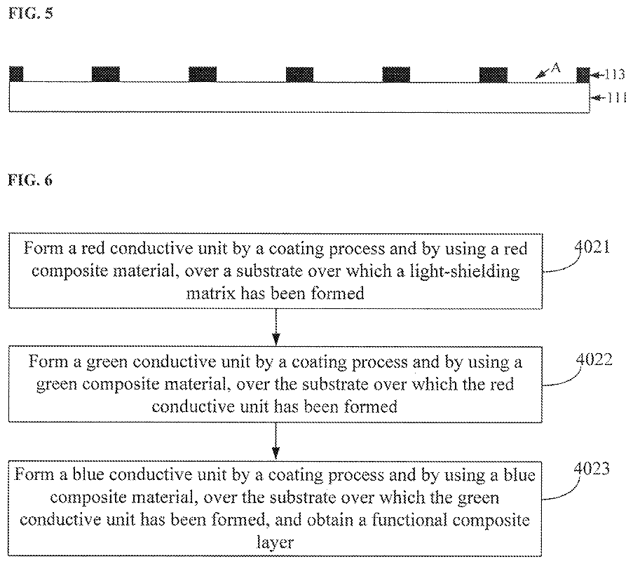

FIG. 6 illustrates a flow chart of an exemplary method of forming an exemplary functional composite layer over a substrate over which an exemplary light-shielding matrix has been formed according to various disclosed embodiments of the present disclosure.

Referring to FIG. 6, at 4021, a red conductive unit is framed by a coating process and by using a red composite material over a substrate over which a light-shielding matrix has been formed.

In some embodiments, the functional composite layer 112 may have a multilayer structure, and thus, the red conductive unit 1121 may have a multilayer structure. FIG. 7 illustrates a schematic view of an exemplary structure after the red conductive unit 1121 is formed over the substrate 111 over which the light-shielding matrix 113 has been formed according to various disclosed embodiments of the present disclosure. As shown in FIG. 7, the red conductive unit 1121 is located in one of the open regions (not marked in FIG. 7) of the light-shielding matrix 113. In some embodiments, the red conductive unit 1121 may have a multilayer structure (not shown in FIG. 7). In some embodiments, the red conductive unit 1121 may be formed by a multiple coating process and by using a red composite material, over the substrate 111 on which the light-shielding matrix 113 has been formed. For example, if the red conductive unit 1121 includes three sublayers, the red conductive unit 1121 may be formed by performing a coating process for three times, over the substrate 111 over which the light-shielding matrix 113 has been formed. One sublayer of the red conductive unit 1121 may be formed by performing the coating process for one time.

Ingredients of the red composite material may include one or more of a red quantum dot, a graphene, an adhesive, a curing agent, an accelerant, a diluent, etc. The red quantum dot may include a II-VI quantum dot. The red quantum dot may be used for converting white light into red light, and a weight percentage of the red quantum dot may range from approximately 10% to approximately 20%. The graphene may be used for conducting electricity. A weight percentage of the graphene may range from approximately 40% to approximately 65%. The adhesive may cause the red composite material to have a certain viscosity and a certain degree of adhesion. The adhesive may include epoxy resin, e.g., bisphenol A-type epoxy resin. A weight percentage of the adhesive may range from approximately 20% to approximately 40%. The curing agent can make the quantum dot cured on a surface of graphene layers. The curing agent may include dicyandiamide, p-phenylenediamine, or another suitable material. A weight percentage of the curing agent may range from approximately 1% to approximately 10%. An accelerant may serve as an additive, and may include imidazole, dimethylimidazole, triethylamine, or another appropriate material. A weight percentage of the accelerant may range from approximately 0.3% to approximately 8%. The diluent may serve as an additive, and may include at least one of isopropanol, acetone, or n-butanol. A weight percentage of the diluent may range from approximately 3% to approximately 10%. The above descriptions of the red composite material are merely for illustrative and exemplary purposes. The red composite material may also include other ingredients, and the weight percentages of the ingredients may be selected in different ranges according to various application scenarios, which are not limited in the present disclosure.

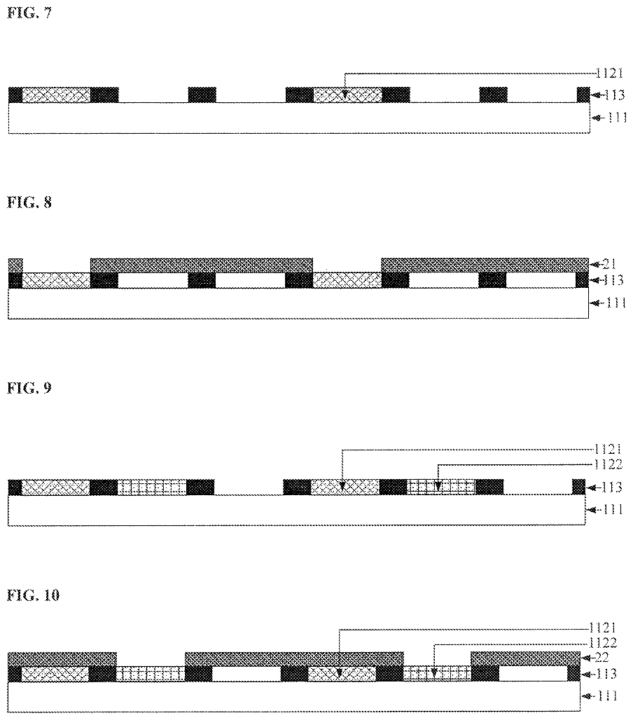

In some embodiments, using a red composite material, the red conductive unit 1121 may be formed by a first mask plate and a coating process. The first mask plate may include a light-transmissive region and a light-blocking region. FIG. 8 illustrates a schematic view of forming a red conductive unit over a substrate over which a light-shielding matrix has been formed according to various disclosed embodiments of the present disclosure. In some embodiments, as shown in FIG. 8, the first mask plate 21 is disposed over the light-shielding matrix 113, such that light-transmissive regions (not marked in FIG. 8) of the first mask plate 21 are aligned with regions of red conductive units 1121 to be formed, and the light-blocking regions (not marked in FIG. 8) of the first mask plate 21 block regions other than the regions of red conductive units 1121 to be formed. Further, a plurality of red composite material layers may be coated over the substrate 111 over which the light-shielding matrix 113 has been framed, through the first mask plate 21. Further, the first mask plate 21 may be removed and the red conductive unit 1121 may be obtained. A schematic view of an exemplary structure after the first mask plate 21 is removed can be referred to FIG. 7.

At 4022, a green conductive unit is formed by a coating process and by using a green composite material, over the substrate over which the red conductive unit has been formed.

In some embodiments, the functional composite layer 112 may have a multilayer structure, and thus, the green conductive unit 1122 may have a multilayer structure. FIG. 9 illustrates a schematic view of an exemplary structure after the green conductive unit 1122 is formed over the substrate 111 over which the red conductive unit 1121 has been formed according to various disclosed embodiments of the present disclosure. Referring to FIG. 9, the green conductive unit 1122 is located in an open region (not marked in FIG. 9) of the light-shielding matrix 113, and the green conductive unit 1122 may have a multilayer structure (not shown in FIG. 9). In some embodiments, the green conductive unit 1122 may be formed by a multiple coating process and by using a green composite material, over the substrate 111 over which the red conductive unit 1121 has been formed. For example, if the green conductive unit 1122 includes three sublayers, the green conductive unit 1122 may be formed by performing a coating process for three times, over the substrate 111 over which the red conductive unit 1121 has been formed. One sublayer of the green conductive unit 1122 may be formed by performing the coating process for one time.

Ingredients of the green composite material may include one or more of a green quantum dot, a graphene, an adhesive, a curing agent, an accelerant, a diluent, etc. The green quantum dot may include a I-III-VI quantum dot. The green quantum dot may be used for converting white light into green light, and a weight percentage of the green quantum dot may range from approximately 10% to approximately 20%. The graphene may be used for conducting electricity. A weight percentage of the graphene may range from approximately 40% to approximately 65%. The adhesive may cause the green composite material to have a certain viscosity and a certain degree of adhesion. The adhesive may include epoxy resin, e.g., bisphenol A-type epoxy resin. A weight percentage of the adhesive may range from approximately 20% to approximately 40%. The curing agent can make the quantum dot cured on a surface of graphene layers. The curing agent may include dicyandiamide, p-phenylenediamine, or another suitable material. A weight percentage of the curing agent may range from approximately 1% to approximately 10%. The accelerant may serve as an additive, and may include imidazole, dimethylimidazole, triethylamine, or another appropriate material. A weight percentage of the accelerant may range from approximately 0.3% to approximately 8%. The diluent may serve as an additive, and may include at least one of isopropanol, acetone, or n-butanol. A weight percentage of the diluent may range from approximately 3% to approximately 10%. The above descriptions of the green composite material are merely for illustrative and exemplary purposes. The green composite material may further include other ingredients, and the weight percentages of the ingredients may be selected in different ranges according to various application scenarios, which are not limited in the present disclosure.

In some embodiments, using a green composite material, the green conductive unit 1122 may be formed by a second mask plate and a coating process. The second mask plate may include light-transmissive regions and light-block regions. FIG. 10 illustrates a schematic view of forming a green conductive unit over a substrate over which a red conductive unit has been formed according to various disclosed embodiments of the present disclosure. In some embodiments, as shown in FIG. 10, the second mask plate 22 is disposed over the light-shielding matrix 113, such that the light-transmissive regions (nor marked in FIG. 10) of the second mask plate 22 are aligned with regions of green conductive units 1122 to be framed, and the light-blocking regions (not marked in FIG. 10) of the second mask plate 22 block regions other than the regions of green conductive units 1122 to be formed. Further, a plurality of green composite material layers may be coated over the substrate 111 over which the red conductive unit 1121 has been formed, through the second mask plate 22. Further, the second mask plate 22 may be removed and the green conductive unit 1122 may be obtained. A schematic view of an exemplary structure after the second mask plate 22 is removed is shown in FIG. 9.

At 4023, a blue conductive unit is formed by a coating process and by using a blue composite material, over the substrate over which the green conductive unit has been formed, and a functional composite layer is obtained.

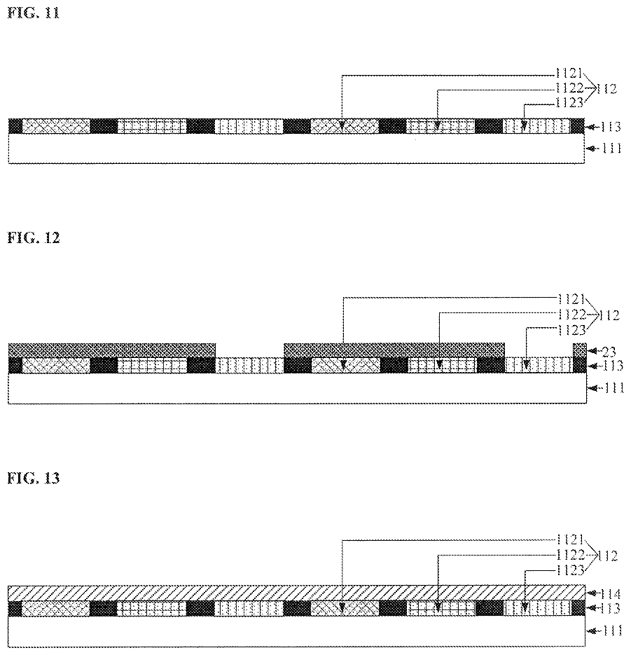

In some embodiments, the functional composite layer 112 may have a multilayer structure, and thus, the blue conductive unit 1123 may have a multilayer structure. FIG. 11 illustrates a schematic view of an exemplary structure after the blue conductive unit 1123 formed over the substrate 111 over which the green conductive unit 1122 has been formed according to various disclosed embodiments of the present disclosure. Referring to FIG. 11, the blue conductive unit 1123 is located in an open region (not marked in FIG. 11) of the light-shielding matrix 113, and the blue conductive unit 1123 may have a multilayer structure (not shown in FIG. 11). In some embodiments, the blue conductive unit 1123 may be formed by a multiple coating process and by using a blue composite material, over the substrate 111 over which the green conductive unit 1122 has been framed. For example, if the blue conductive unit 1123 includes three sublayers, the blue conductive unit 1123 may be formed by performing a coating process for three times, over the substrate 111 over which the green conductive unit 1122 has formed. One sublayer of the blue conductive unit 1123 may be formed by performing the coating process for one time.

Ingredients of the blue composite material may include one or more of a blue quantum dot, a graphene, an adhesive, a curing agent, an accelerant, a diluent, etc. The blue quantum dot may include a rare-earth quantum dot. The blue quantum dot may be used for converting white light into blue light, and a weight percentage of the blue quantum dot may range from approximately 10% to approximately 20%. The graphene may be used for conducting electricity. A weight percentage of the graphene may range from approximately 40% to approximately 65%. The adhesive may cause the blue composite material to have a certain viscosity and a certain degree of adhesion. The adhesive may include epoxy resin, e.g., bisphenol A-type epoxy resin. A weight percentage of the adhesive may range from approximately 20% to approximately 40%. The curing agent can make the quantum dot cured on a surface of graphene layers. The curing agent may include dicyandiamide, p-phenylenediamine, or another suitable material. A weight percentage of the curing agent may range from approximately 1% to approximately 10%. The accelerant may serve as an additive, and may include imidazole, dimethylimidazole, triethylamine, or another appropriate material. A weight percentage of the accelerant may range from approximately 0.3% to approximately 8%. A diluent may serve as an additive, and may include at least one of isopropanol, acetone, or n-butanol. A weight percentage of the diluent may range from approximately 3% to approximately 10%. The above descriptions of the blue composite material are merely for illustrative and exemplary purposes. The blue composite material may further include other ingredients, and the weight percentages of the ingredients may be selected in different ranges according to various application scenarios, which are not limited in the present disclosure.

In some embodiments, using a blue composite material, the blue conductive unit 1123 may be formed by a third mask plate and a coating process. The third mask plate may include light-transmissive regions and light-blocking regions. FIG. 12 illustrates a schematic view of forming a blue conductive unit over a substrate over which a green conductive unit has been formed according to various disclosed embodiments of the present disclosure. In some embodiments, as shown in FIG. 12, the third mask plate 23 is disposed over the light-shielding matrix 113, such that light-transmissive regions (not marked in FIG. 12) of the third mask plate 23 are aligned with regions of blue conductive units 1123 to be formed, and the light-blocking regions (not marked in FIG. 12) of the third mask plate 23 block regions other than the regions of blue conductive units 1123 to be formed. Further, a plurality of blue composite material layers may be coated over the substrate 111 over which the green conductive unit 1122 has been formed, through the third mask plate 23. Further, the third mask plate 23 may be removed, and the blue conductive unit 1123 may be obtained. A schematic view of an exemplary structure after the third mask plate 23 is removed is shown in FIG. 11.

After the red conductive unit 1121, the green conductive unit 1122, and the blue conductive unit 1123 are framed, the functional composite layer 112 can be obtained. In embodiments of the present disclosure, when the functional composite layer 112 is formed descriptions are made for scenarios that the red conductive unit 1121 is formed first, and then the green conductive unit 1122 is framed and finally the blue conductive unit 1123 is formed, as examples. In some other embodiments, the order for formation of the red conductive unit 1121, the green conductive unit 1122, and the blue conductive unit 1123 can be adjusted. That is, the order of processes 4021-4023 can be adjusted. It should be appreciated that variations may be made to the embodiments described for the processes 4021-4023 by persons skilled in the art, all of which are within the scope of the present disclosure.

In embodiments of the present disclosure, descriptions are made for scenarios that the functional composite layer 112 is formed by a coating process, as examples, hi some other embodiments, the functional composite layer 112 may be formed by an ink-jet printing process, a transfer process, a drop casting process, or another appropriate process, which is not restricted in the present disclosure.

Referring again to FIG. 4, at 403, a polarizer layer is formed over the substrate over which the functional composite layer has been formed.

As an example, FIG. 13 illustrates a schematic view of an exemplary structure after the polarizer layer 114 is formed over the substrate 111 over which the functional composite layer 112 has been formed according to various disclosed embodiments of the present disclosure. The polarizer layer 114 can be, for example, a polarizer plate. In some embodiments, the polarizer plate may be attached to the functional composite layer 112 by an attaching process to serve as the polarizer layer 114. In some other embodiments, the polarizer plate may be fabricated over the functional composite layer 112 by a polarizer plate fabrication process, to serve as the polarizer layer 114. The manner of preparing the polarizer layer is not restricted, and may be selected according to various application scenarios. In some embodiments, the functional composite layer 112 may be formed of at least one composite material. A surface of the composite material may include a hydroxyl group, a carboxyl group, and other appropriate functional groups. A hydroxyl group, a carboxyl group, or another appropriate functional group may make the composite material hydrophilic to some degree. A material of the polarizer plate may have has a certain water solubility. Thus, a hydroxyl group, a carboxyl group, or another appropriate functional group may attach the polarizer plate to the functional composite layer 112.

At 404, a photo spacer layer is framed over the substrate over which the polarizer layer has been formed.

Reference can be made to FIG. 3 for a schematic view of a structure after the photo spacer layer 115 is formed over the substrate 111 over which the polarizer layer 114 has been formed. As shown in FIG. 3, the photo spacer layer 115 includes a plurality of photo spacers 1151. A photo spacer may have a columnar structure, e.g., a cylindrical structure, a circular table structure, a prismatic structure, or the like. In some embodiments, as shown in FIG. 3, the photo spacer 1151 has a trapezoidal vertical cross section. In some embodiments, the photo spacer layer 115 may be formed by using an organic resin material.

In some embodiments, an layer of organic resin material may be deposited to form an organic resin film, by coating, magnetron sputter, thermal evaporation, plasma enhanced chemical vapor deposition (PECVD), or another appropriate method, over the substrate 111 over which the polarizer layer 114 has been formed. Then, the organic resin film may be exposed with a mask plate to form fully exposed regions and non-exposed regions of the organic resin film. A development process may be applied to remove organic resin film in the fully exposed regions and to retain organic resin film in the non-exposed regions, and thus to form the photo spacers 1151 in the non-exposed regions. Accordingly, the photo spacer layer 115 may be obtained.

The present disclosure provides a fabrication method for a color film substrate. The color film substrate may include a functional composite layer which is electrically conductive and capable of converting white light into color light. Thus, the functional composite layer may serve as a color filter layer and a common electrode. That is, the function of the color filter layer and the function of the common electrode can be realized by the functional composite layer. Accordingly, the color film substrate fabricated by the fabrication method of the disclosure may have a relatively small number of layers, as compared to the conventional technologies, in which a color film substrate may have a relatively large thickness and a thin and light-weight device may be difficult to achieve. The color film substrate fabricated by the fabrication method of the disclosure may have a relatively small thickness, facilitating the realization of a thin and light-weight display device.

Further, in the color film substrate fabricated by the fabrication method of the disclosure, the function of the color filter layer may be realized by using a quantum dot. The quantum dot may include, for example, at least one of a red quantum dot, a green quantum dot, a blue quantum dot, or another appropriate quantum dot. The quantum dot may have a high spectrum intensity and a wide color gamut range. Thus, the color film substrate may have a relatively wide color gamut range and a relatively high color saturation. Further, in the color film substrate fabricated by the fabrication method of the disclosure, the function of the common electrode may be realized by using a graphene, with no need to further form a common electrode. A damage to the color filter layer, caused by the process of forming the common electrode is formed, may be suppressed. Accordingly, fabrication processes may be reduced, and production costs may be reduced.

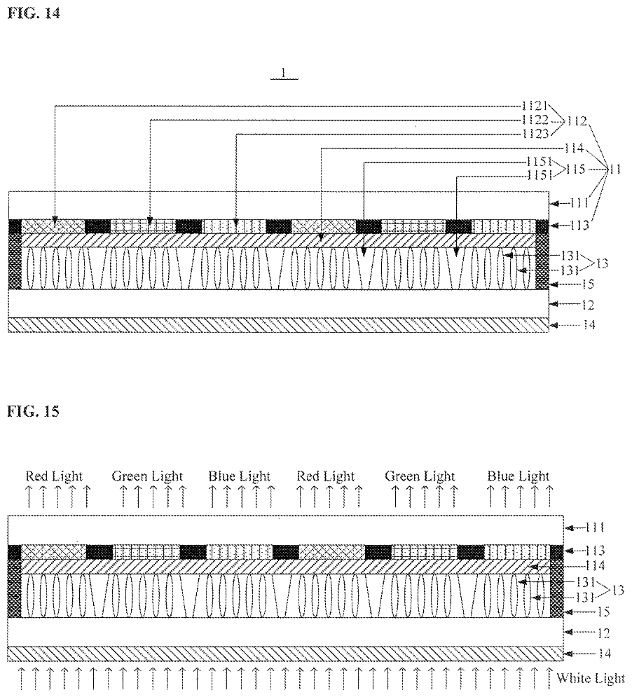

FIG. 14 illustrates a schematic view of an exemplary display device 1 according to various disclosed embodiments of the present disclosure. The exemplary display device 1 can be, for exemplary, a twisted-nematic type display device. As shown in FIG. 14, the exemplary display device 1 includes the color film substrate 11 and an array substrate 12 paired to form a box, and a liquid crystal layer 13 between the color film substrate 11 and the array substrate 12. The liquid crystal layer 13 includes a plurality of liquid crystal molecules 131. The color film substrate 11 may be, for example, the color film substrate shown in FIG. 2 or FIG. 3. A sealing frame 15 is provided between the color film substrate 11 and the array substrate 12, and the liquid crystal molecules 131 are located in a space enclosed by the sealing frame 15.

As shown in FIG. 14, the color film substrate 11 includes the substrate 111, and the light-shielding matrix 113, the functional composite layer 112, the polarizer layer 114, and the photo spacer layer 115 successively formed over the substrate 111. The light-shielding matrix 113 includes a plurality of open regions. The functional composite layer 112 includes a plurality of color conductive units. The plurality of color conductive units include the red conductive unit 1121, the green conductive unit 1122, and the blue conductive unit 1123. Each open region of the light-shielding matrix 113 is provide with a color conductive unit. The photo spacer layer 115 includes the plurality of photo spacers 1151 which can support the array substrate 12 and the color film substrate 11, such that a space is formed between the array substrate 12 and the color film substrate 11. The liquid crystal molecules 131 are located in the space formed with the support of photo pacers 1151.

Further, as shown in FIG. 14, the array substrate 12 has one side facing toward the color film substrate 11, and an opposing side dicing away from the color film substrate 11. A polarizer plate 14 is provided over the opposing side of the array substrate 12 dicing away from the color film substrate 11. A polarization direction of the polarizer plate 14 may be perpendicular to a polarization direction of the polarizer layer 114, such that light can be emitted out from the display device 1.

In embodiments of the present disclosure, the array substrate 12 may include thin film transistors (TFTs) (not shown in FIG. 14) and pixel electrodes (not shown in FIG. 14). By applying voltage signals to the pixel electrodes through the TFTs and voltage signals to the functional composite layer 112 of the color film substrate 12 simultaneously, voltage differences may be formed between the array substrate 12 and the color film substrate 12. The liquid crystal molecules 131 in the liquid crystal layer 13 may rotate under influences of the voltage differences.

The display device 1 can be, for example, a mobile phone, a tablet computer, a television, a monitor, a notebook computer, a digital photo frame, a navigating instrument, or any other suitable product or component having a display function. Any display device including a color film substrate consistent with the disclosure is within the scope of the present disclosure.

FIG. 13 illustrates a schematic view showing an operation of an exemplary display device according to various disclosed embodiments of the present disclosure. As shown in FIG. 15, white light enters the display device from a side corresponding to the array substrate 12. The white light can transmit through the liquid crystal layer 13 and enter the color film substrate due to the rotation of the liquid crystal molecules 131, and finally can be emitted out from the display device through the color film substrate. When the white light is passing through the color film substrate, the red conductive unit of the functional composite layer can convert the white light into red light, the green conductive unit of the functional composite layer can convert the white light into green light, and the blue conductive unit can convert the white light into blue light, such that the display device 1 can display a color image.

The array substrate 12 may include components similar to those of the array substrate 81 shown in FIG. 1, and thus detailed description thereof is omitted.

The present disclosure provides a display device. The color film substrate in the display device of the disclosure may include a functional composite layer which is electrically conductive and configured to convert white light into color light. Thus, the functional composite layer may serve as a color filter layer and a common electrode. That is, the function of the color filter layer and the function of the common electrode can be realized by the functional composite layer. Accordingly, the color film substrate in the display device of the disclosure may have a relatively small number of layers, as compared to the conventional technologies in which a color film substrate may have a relatively large thickness and it may be hard to achieve a thin and light-weight device. The color film substrate in the display device of the disclosure may have a relatively small thickness, facilitating the realization of a thin and light-weight display device.

In the display device of the present disclosure, the polarizer layer may be provided over the functional composite layer of the color film substrate. Further, the polarizer layer may be located in a liquid crystal box after the color film substrate and the array substrate are paired to form a box. Thus, an embedded polarizer layer may be realized, and the thickness of the display device may be further reduced.

The present disclosure provides a color film substrate, a fabrication method thereof and a display device. The color film substrate may include a substrate and a functional composite layer arranged over the substrate. The functional composite layer can be electrically conductive and can convert white light into color light. The functional composite layer may be formed by at least one composite material. The composite material may include a quantum dot and a graphene. The quantum dot may include, for example, at least one of a red quantum dot, a green quantum dot, a blue quantum dot, or another appropriate quantum dot. The present disclosure may reduce a thickness of the color film substrate, and may facilitate a reduced thickness and a reduced weight of the display device.

It will be understood by those of ordinary skill in the art that, all or part of the steps of the embodiments described above may be accomplished by hardware, or by means of programs which instruct associated hardware. The programs in a computer readable storage medium. The storage medium can be a read-only memory, a magnetic disk, an optical disk, or another appropriate storage medium.

The foregoing description of the embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to persons skilled in this art. The embodiments are chosen and described in order to explain the principles of the technology, with various modifications suitable to the particular use or implementation contemplated. It is intended that the scope of the invention be defined by the claims appended hereto in which all terms are meant in their broadest reasonable sense unless otherwise indicated. Therefore, the term “the disclosure,” “the present disclosure,” or the like does not necessarily limit the claim scope to a specific embodiment, and the reference to exemplary embodiments of the disclosure does not imply a limitation on the invention, and no such limitation is to be inferred. Moreover, the claims may refer to “first,” “second,” etc., followed by a noun or element. Such terms should be understood as a nomenclature and should not be construed as giving the limitation on the number of the elements modified by such nomenclature unless specific number has been given. Any advantages and benefits described may or may not apply to all embodiments of the disclosure. It should be appreciated that variations may be made to the embodiments described by persons dolled in the art without departing from the scope of the present disclosure. Moreover, no element or component in the presort disclosure is intended to be dedicated to the public regardless of whether the element or component is explicitly recited in the following claims.

1. A color film substrate comprising:
a substrate, and
a functional composite layer over the substrate and being electrically conductive,
wherein:
the functional composite layer includes a composite material including a quantum dot and a grapheme, and is configured to convert white light into color light.

2. The color film substrate according to claim 1, wherein:
a weight percentage of the quantum dot in the composite material is in a range from approximately 10% to approximately 20%, and
a weight percentage of the graphene in the composite material is in a range from approximately 40% to approximately 65%.

3. The color film substrate according to claim 1, wherein:
the functional composite layer includes a plurality of color conductive units having approximately equal thicknesses.

4. The color film substrate according to claim 3, wherein:
the plurality of color conductive units include a red conductive unit, a green conductive unit, and a blue conductive unit.

5. The color film substrate according to claim 4, wherein:
the red conductive unit includes a red composite material,
the green conductive unit includes a green composite material, and
the blue conductive unit includes a blue composite material.

6. The color film substrate according to claim 3, wherein the thicknesses of the color conductive units are in a range from approximately 1.3 mm to approximately 2.3 mm.

7. The color film substrate according to claim 3, further comprising:
a light-shielding matrix arranged over the substrate,
wherein:
the light-shielding matrix includes a plurality of open regions arranged in an array, and
one of the color conductive units is in one of the open regions.

8. The color film substrate according to claim 1, further comprising:
a polarizer layer over the functional composite layer.

9. The color film substrate according to claim 8, further comprising:
a photo spacer layer over the polarizer layer.

10. The color film substrate according to claim 1, wherein the functional composite layer has a multilayer structure.

11. A method for fabricating a color film substrate, comprising:
providing a substrate; and
forming a functional composite layer over the substrate using a composite material including a quantum dot and a graphene, the functional composite layer being electrically conductive.

12. The method according to claim 11, wherein forming the functional composite layer over the substrate includes:
forming a composite layer by a coating process.

13. The method according to claim 11, further comprising:
forming a light-shielding matrix over the substrate, the light-shielding matrix including a plurality of open regions,
wherein forming the functional composite layer over the substrate includes forming a plurality of color conductive units, one of the color conductive units being formed in one of the open regions of the light-shielding matrix.

14. The method of claim 13, wherein forming the functional composite layer over the substrate includes:
forming a red conductive unit in a first one of the open regions of the light-shielding matrix by a first coating process using a red composite material including a red quantum dot;
forming a green conductive unit in a second one of the open regions of the light-shielding matrix by a second coating process using a green composite material including a green quantum dot; and
forming a blue conductive unit in a third one of the open regions of the light-shielding matrix by a third coating process using a blue composite material including a blue quantum dot.

15. The method according to claim 13, further comprising:
forming a polarizer layer over the functional composite layer.

16. The method according to claim 15, further comprising:
forming a photo spacer layer over the polarizer layer.

17. A display device, comprising the color film substrate according to claim 1.
